(19) United States
(12) Patent Application Publication
(10) Pub. No.: US 2009/0096120 A1
(43) Pub. Date: Apr. 16, 2009

(54) PROBE SENSOR AND METHOD FOR A POLYMERIC PROCESS

(75) Inventors: Suresh Subramonian, Midland, MI (US); Christine Kruse (nee Carlson), Midland, MI (US); Eugene Liening, Tittabawasee Twp., MI (US)

Correspondence Address: THE DOW CHEMICAL COMPANY / DOBRUSIN & THENNISCH PC, 29 W. LAWRENCE STREET, STE. 210, PONTIAC, MI, 48342, US

(73) Assignee: Dow Global Technologies Inc.

(21) Appl. No.: 12/207,937

(22) Filed: Sep. 10, 2008

Related U.S. Application Data
(60) Provisional application No. 60/979,151, filed on Oct. 11, 2007.

(51) Int. Cl. B29C 45/76; G01N 27/26

(52) U.S. Cl. 264/40.1; 204/404

(57) ABSTRACT

A method for processing a polymeric article, by introducing ingredients including a polymeric material for forming a polymeric article into an apparatus including a wall surface over which the polymeric material travels in at least a fluidic state, and an orifice through which the ingredients exit the apparatus. The ingredients are mixed while in the apparatus to form a polymeric ingredients mixture. A corrosion response of the wall surface of the apparatus is monitored with at least one resistance corrosion sensing probe that is flush mounted with the interior wall surface. The polymeric mixture is solidified after it exits the orifice for forming the polymeric article and mitigating corrosion detected by the monitoring step.

### CLAIM OF PRIORITY

The present application claims the benefit of the filing date of U.S. Provisional Application No. 60979151 (filed 11 OCT. 2007) the contents of which are hereby incorporated by reference in their entirety.

### FIELD OF THE INVENTION

The present invention relates to corrosion sensing and more particularly to the use of improved flush mounted probe sensors for sensing corrosion in processing apparatus for the manufacture of polymeric articles.

### BACKGROUND OF THE INVENTION

In the field of polymer processing, and other chemical processing operations, it is common that one or more of the processed ingredients will intrinsically be corrosive to the apparatus into which they are introduced. It is also possible that the ingredients combine or chemically or physically react while in the apparatus to create a corrosive media that may be harmful to the apparatus. For example, in the manufacture of some foamed polymeric articles, certain potentially corrosive ingredients are used, which may be harmful to processing apparatus, such as by corroding the ferritic materials of an extruder, a mixer, a die or other such associated apparatus. System breakdown due to corrosion can result in extensive downtime. Therefore it is beneficial to accurately monitor corrosion and degradation rates to assist the timely substitution or repair of compromised components or to take other mitigation actions.

One approach to such monitoring is to employ resistance corrosion sensors within the apparatus. Resistance corrosion sensors generally employ one or more sensing elements embedded in an epoxy potting material, within a housing, along with suitable hardware for signaling communication with an electrical source and a signal processor or other data acquisition hardware. The electrical response of the sensing elements to the signal from the electrical source is monitored by the signal processor or other data acquisition hardware. As the sensing element corrodes, its area and volume erode, and a change of resistance of the element results. The change of resistance is thus detectable and can be correlated with the extent of corrosion. Alternatively, or additionally, the change of resistance of a sensing probe is compared with a reference element that is not subjected to the corrosive medium, so that differences between the sensing element and the reference element can be monitored.

Flush probes have been employed as a form of resistance sensor. Generally, the probe includes a sensing element that is made from a material that is identical or nearly identical to the monitored material. The sensing element is mounted so that it is flush with the surface of the apparatus for which monitoring is desired. Flush probes have been employed in various applications, such as in gas and oil pipelines environments and certain aqueous chemical processing environments. In those environments, the apparatus monitored is commonly subjected to steady state continuous flow conditions, typically under elevated pressures. Examples of such probes are in U.S. Pat. Nos. 3,996,124; 4,514,681; and 7,034,553, incorporated by reference. These probes, though robust for their particular applications are not typically subjected to the same environmental conditions found in polymer processing, which typically employ elevated temperatures and pressures. Under such conditions, the probes are believed incapable of resisting degradation of the potting material, rendering the probe susceptible to inaccurate sensor data and premature failure. For example, under conditions typically experienced for polymer processing (e.g. exposure to certain fluids under supercritical conditions, such as carbon dioxide, ethanol, or the like), epoxy potting materials are not only subject to degradation effects of any corrosive agent. They also are prone to the consequences of harsh solvents that arise and to dissolve, swell, or otherwise deteriorate. Such deterioration has the effect of distorting measurements. Accordingly, industry has avoided the use of such probes for applications with environmental conditions found in polymer processing.

Currently, corrosion measurements in polymer processing apparatus are generally conducted using pre-weighed and pre-measured coupons of the desired material. They are inserted in a melt stream at the start of the test and removed at the end of the test. The coupons are cleaned with solvent and inhibited acid and re-weighed, re-measured and analyzed for damage with a microscope. The corrosion rate is determined from the weight loss using the following equation for uniform corrosion: corrosion rate (typically expressed as millimeters per year (mm/yr)) equals the product of 88 times the weight loss (expressed in milligrams (mg)) divided by the product of sample density (expressed in grams per cubic centimeter) times exposed area of specimen (expressed in square centimeters (cm²)) times exposure time (expressed in hours (hr).

Corrosion rates of less than 0.15 mm/yr are generally indicative of good corrosion resistance and materials in this category are selected for critical wetted apparatus parts in corrosive service. The apparatus life can then be calculated knowing the corrosion allowance incorporated in the apparatus design by an equation in which the corrosion allowance (expressed in allowable corrosion amount, e.g., millimeters) is divided by the corrosion rate (e.g., millimeters per year).

This current technique has practical limitations and disadvantages. First, to insert and remove the coupons, the polymer processing apparatus has to be shut down and the line has to be cooled to freeze the polymer and these results in significant apparatus down time and lost production in manufacturing. Further, a hydraulic device is required to insert and seat the coupon in the flange of the line and this requires significant operator effort and there is the possibility of leaks and damage to the coupon during insertion and removal that can affect the weight loss and corrosion rate. Also, the average corrosion rate can be determined cumulatively over the trial period in retrospect but the instantaneous effect of varying process conditions or formulation cannot be established; any failure cannot be tracked for corrective action and can result in unscheduled and expensive shutdowns.

Accordingly, it would be desirable to have a flush mounted type corrosion probe that provides a real-time display of corrosion rates, particularly for a polymer processing system or other system that handles corrosive formulations. It would be especially useful to enable the determination of the effect of ingredients and processing conditions (e.g. steady state operation, hot shut-downs, process upsets, batch processes) on the instantaneous corrosion rates and to evaluate and implement options to mitigate the corrosive effects on the affected parts of the polymer processing line.

### SUMMARY OF THE INVENTION

The present invention solves one or more of the above problems by providing improved sensing probes and methods that facilitate corrosion monitoring, especially for use in processing of plastics to form polymeric articles.

Accordingly, pursuant to one aspect of the present invention, there is contemplated a method for processing a polymeric article, comprising the steps of introducing ingredients, including a polymeric material, for forming a polymeric article into an apparatus including an interior wall surface over which the polymeric material travels in at least a fluidic state, and an orifice through which the ingredients exit the apparatus; mixing the ingredients while in the apparatus to form a polymeric ingredients mixture; monitoring a corrosion response of the interior wall surface of the apparatus with at least one resistance corrosion sensing probe that is flush mounted with the interior wall surface, wherein the at least one resistance corrosion sensing probe provides an accurate corrosion reading within 10% of an actual measured corrosion for at least seven days; solidifying the polymeric mixture after it exits the orifice for forming the polymeric article; and mitigating corrosion detected by the monitoring step.

The invention may be further characterized by one or any combination of the features described herein, such as the probe including a sintered ceramic potting material; any water that is present in the polymeric ingredients mixture is present in an amount that is less than about 50% by weight (or even less than about 10% by weight, and more preferably less than about 3% by weight) of the mixture; the polymeric ingredients mixture includes at least two ingredients that chemically or physically react to form an acidic medium; in one specific example the polymeric ingredients mixture includes a flame retardant as one of the at least two ingredients (e.g., the polymeric ingredients mixture includes a styrenic polymeric thermoplastic material, an aqueous blowing agent and a halogenated flame retardant that react to form an acidic medium and the resulting article is an expanded styrenic polymeric closed-cell foam extruded panel); the apparatus includes at least one or more of an extruder, a mixer, a cooling apparatus and a die, that the probe is mounted within at least one of the mixer, a cooling apparatus, interconnecting piping, or die, thus (for example) an aqueous blowing agent and a halogenated flame retardant may be introduced individually into the mixer, the extruder, or any appropriate place within the apparatus and thereafter will react to form an acidic medium; or the sensing probe includes a housing including a sensing portion that terminates at a sensing end of the housing, a potting material filling the sensing portion of the housing, a metallic sensing element including an exposed portion and a portion connected with the exposed portion that is embedded in the potting material, and means for signally communicating the electrical response of the sensing element with a signal processor, pursuant to which erosion of the sensing element results in a change of resistance of the sensing element that is detected by the signal processor; wherein the potting material is capable of resisting degradation, by which the potting material is exposed to temperatures ranging from about ambient (e.g. apparatus is shut down) to generally less than about 300° C., pressures ranging from about 5 to 25 MPa, a pH below about 7 and in the presence of a solvent.

Another aspect of the present invention contemplates a corrosion sensor, comprising a) a housing including a sensing portion that terminates at a sensing end of the housing; b) a potting material filling the sensing portion of the housing; c) a metallic sensing element including an exposed portion and a portion connected with the exposed portion that is embedded in the potting material; d) and means for signally communicating the electrical response of the sensing element with a signal processor, pursuant to which erosion of the sensing element results in a change of resistance of the sensing element that is detected by the signal processor; wherein the potting material is capable of resisting swelling when degradation, the corrosion sensor providing an accurate corrosion reading within 10% of an actual measured corrosion for at least seven days when exposed to running temperatures greater than about 100° C., pressures ranging from about 5 to 25 MPa, and a pH below about 7 in the presence of a solvent.

Such a sensor may further include one or a combination of features such that the exposed portion of the metallic sensing element is located generally at the sensing end of the housing so that when the housing is mounted within a piece of apparatus the metallic sensing element is substantially flush with an inner wall of the piece of apparatus; or the means for signally communicating is a radiofrequency transmitting device. A particularly useful application for such a sensor is in chemical processing, and particularly the manufacture of an extruded styrenic polymeric foam (e.g. closed or open cell).

Among the advantages of the present invention are that a robust approach to monitoring and mitigating the effects of corrosion resistance in a system for processing chemicals and particularly in the manufacture of thermoplastic polymeric articles is possible.

For measurement of corrosion in aggressive process environments, electrical resistance based cylindrical probes are typically employed. The body of such a probe, made from the same metal as the process equipment, projects into the fluid stream and is subjected to the same corrosive environment and therefore, the electrical resistance of the metal element can provide an estimation of the metal loss and corrosion rates in the process equipment. The all welded construction of the cylindrical probe and the absence of any sealing material other than the parent metal make such a probe ideal for aggressive service. However, while such cylindrical probes are suitable for low viscosity (e.g. aqueous) fluid streams, they are not suitable for use in polymer processing equipment as they are liable to deform or twist or even catastrophically shear off and fail in the high viscosity flow environment. Additionally, if such a cylindrical probe is located in a polymer process line sufficiently downstream, close to, for example, an extrusion die, it can cause splitting of the polymer flow stream that does not heal in the limited residence time in the line prior to exiting the die resulting in possible defects, flaws or imperfections visible in the polymer product. The present invention provides an improved corrosion sensor that represents an advancement over the existing probe technology as it does not cause any substantial distortion of the polymer flow even if it is located close to an extrusion die and the sensor is adequately robust to handle harsh polymer processing environments and aggressive supercritical solvents. Thus, the present invention represents an advancement over current corrosion probes as it surprisingly provides the benefits of both the cylindrical probe and the flush probe without the associated disadvantages of either, enabling its use to accurately monitor corrosion in aggressive harsh environments encountered in polymer processing equipment. The benefits of the invention are that the state of the processing equipment can be monitored on a continuous basis and corrective action can be taken in a timely manner to avoid the risk of any system failure due to corrosion that can endanger the health and safety of the equipment operators.

It should be appreciated that the above referenced aspects and examples are non-limiting as others exist within the present invention, as shown and described herein.

### BRIEF DESCRIPTION OF THE DRAWINGS

FIG. 1 illustrates a polymer processing system in accordance with one aspect of the present invention.

FIG. 2 is an illustrative depiction of a sensing probe in accordance with another aspect of the present invention.

FIG. 3 is another illustrative depiction of a sensing probe in accordance with another aspect of the present invention.

FIG. 4 is an illustrative depiction of a sensing probe mounted in processing apparatus in accordance with another aspect of the present invention.

### DETAILED DESCRIPTION

As used herein, the following abbreviations shall have the following meaning:

| | |
|---|---|
| mil | 1/1000^{th} of an inch |
| mg | Milligram - a unit of mass and weight equal to one thousandth of a gram |
| sq cm | Square Centimeter |
| cc | Cubic Centimeter |
| hr | Hour |
| yr | Year |
| Pa | Pascal |
| M | Mega (10⁶) |
| k | Kilo (10³) |
| ° C. | Temperature (degrees Celsius) |
| pH | Measure of the acidity or alkalinity of a solution. (negative log (base 10) of |
| | the hydrogen ion concentration) |
| ASTM | A designation to denote a standard issued by the standards developing |
| | organization operating under the name ASTM International or American |
| | Society for Testing and Materials (www.astm.org); unless otherwise denoted |
| | (e.g., by a year in the suffix, such as “-00” or “-2000” referring to the 2000 |
| | version), the standards employed herein refer to the most recent standard |
| | issued by ASTM International under the designation as of the application |
| | filing date. |
| ISO | A designation to denote a standard issued by the standards developing |
| | organization operating under the name International Organization for |
| | Standardization (www.iso.org); unless otherwise denoted (e.g., by a year in the |
| | suffix, such as “-00” or “-2000” referring to the 2000 version), the standards |
| | employed herein refer to the most recent standard issued by ISO under the |
| | designation as of the application filing date. |

The present invention is directed at an improved method of chemicals processing, and more preferably the processing of ingredients for forming a polymeric article in a corrosive environment, which employs an improved corrosion monitoring probe. In one preferred embodiment, the improved corrosion monitoring probe is flush mounted to at least one interior wall surface of a processing apparatus (e.g. an extruder, a mixer, a cooling apparatus, interconnecting piping, or a shaping device) so that the probe is at least in partial contact with the ingredients for forming the polymeric material. The present invention is particularly contemplated for use in applications in which the processing apparatus is subjected to corrosive media and thermal and pressure loading or other conditions that make real-time monitoring of corrosion using conventional sensing probes inefficient and impractical, if even possible.

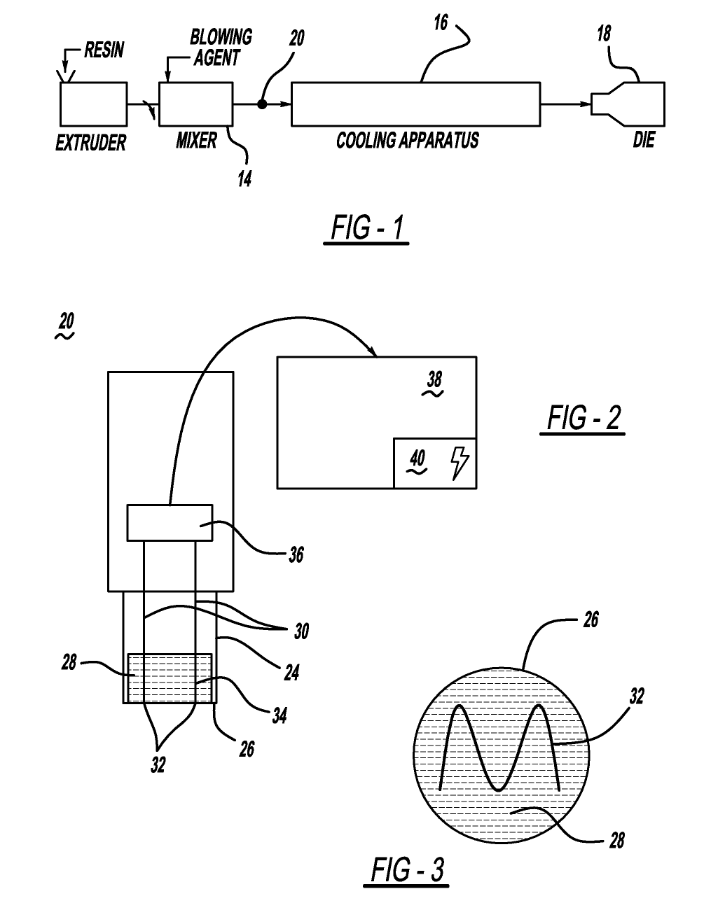

With reference to FIG. 1, one particular preferred application of the aspects of the present invention is in the monitoring of corrosion in apparatus used for manufacturing polymeric articles, and particularly thermoplastic polymeric articles. A particularly preferred application is the manufacture of thermoplastic foam articles, and more preferably thermoplastic closed-cell foam articles, and even more preferably, styrenic polymeric closed cell foam articles, such as insulation panels, packaging or otherwise. The articles therefore may include a network of closed cells containing a CFC-free gas, and may also be free of voids between walls defining the cells.

As indicated, a particularly useful application of the methods and probes herein is in the manufacture of a styrenic polymeric material, such that it may include or consist essentially of polystyrene or blend or copolymer thereof (e.g., a styrene-acrylonitrile copolymer), in a densified state, a foamed state (e.g., including open and closed cell foams) or a combination thereof. For example, one preferred substrate will be a styrenic polymeric foam that exhibits a closed cell structure throughout substantially all of its volume. The styrenic polymeric foam may be an extruded polymeric foam, such as one that has been processed for exhibiting a generally closed cell structure. As used herein, “closed cell” foam structures refer to foams having an open cell content of less than 30%, as determined by ASTM D6226-05, while “open cell” foam structures refer to an open cell content greater than or equal to 30%, as determined by ASTM D6226-05. Specific preferred closed cell foams useful herein may have an open cell content, as determined by ASTM D6226-05, of less than 20% or even less than 10%. An example of one preferred substrate is STYROFOAM™ extruded polystyrene foam insulation (STYROFOAM is a trademark of The Dow Chemical Company).

It should be appreciated that reference to a “styrenic polymeric” material, in the context of the polymeric articles herein, includes polymeric materials containing greater than about 50, preferably about 75 or more, more preferably about 90 or more weight percent of a polymer derived from one or more alkenyl aromatic compounds such as styrene. The polymeric material may be entirely one or more alkenyl aromatic compound. Suitable amounts (e.g., less than 50 percent by weight of the substrate) of copolymerizable compounds, such as C₁₋₄ methacrylates and acrylates, acrylic acid, methacrylic acid, maleic acid, acrylonitrile, maleic anhydride, and vinyl acetate may be incorporated into the styrenic polymeric material.

As it relates to foam-extruded polymeric articles, the present foam structure is generally formed by melting and mixing the polymer (e.g., a styrenic polymer) itself or with other polymers, additive ingredients (such as one or more of pigments, fillers, antioxidants, extrusion aids, nucleating agents, stabilizing agents, antistatic agents, fire retardants, acid scavengers, and infrared attenuators including carbon black and graphite), or both, to form a plastic melt, incorporating a blowing agent into the plastic melt to form a foamable gel, and extruding the foamable gel through a die to form the foamed structure. During melting and mixing, the polymers are heated to a temperature at or above the softening temperature of a polymer. Softening temperature corresponds to the glass transition temperature for amorphous polymers and melting temperature for semi-crystalline polymers. For simplicity herein, heating a polymer above its softening temperature is referred to as melting the polymer and a polymer above its softening temperature is referred to as a melt or molten regardless of whether the polymer is amorphous or semi-crystalline. Melting and mixing of polymers and any additive ingredients is accomplished by any means known in the art such as with an extruder, mixer, or blender. Mixing can be accomplished as a separate step, or it can be integrated into the extrusion step by selecting an extruder embodiment suitable for mixing (e.g., a single screw extruder using a mixing screw or a twin screw extruder). Likewise, the blowing agent (which commonly is a physical blowing agent such as water, carbon dioxide, a hydrocarbon, a halogenated hydrocarbon, or some mixture thereof, is incorporated or blended into the plastic melt by any of the same above-described means. The blowing agent is typically blended with the plastic melt at an elevated pressure sufficient to prevent substantial expansion of the resulting gel or loss of generally homogeneous dispersion of the blowing agent within the gel. By way of example, the blowing agent may be incorporated into the melt in a weight proportion of between about 1 to about 30 parts and preferably from about 3 to 15 parts per hundred parts of the polymer to be expanded.

The resulting foamable gel is preferably passed through a cooling apparatus (e.g., a single screw extruder, a heat exchanger, or some combination thereof to lower the gel temperature to an optimum blowing temperature. For polystyrene, typical optimum blowing temperatures range from about 110° C. to about 135° C. The cooled gel is then passed through the die into a zone of reduced pressure to form the foam structure.

In general, one method suitable for such manufacture of such articles in mass production quantities requires not only the processing of ingredients to form a resulting article, but the monitoring of apparatus used in the production for the presence of corrosion, and one or more steps of mitigating corrosion that is detected. For example, a step of mitigating the corrosion may involve replacing one or more components of an apparatus, repairing one or more such components, modifying the ingredients, or any combination thereof. For example, one possible mitigating step includes adding a stabilizing additive (e.g. flame retardant stabilizer, a desiccant, or any combination thereof), adding an acid scavenger, or both.

In general, the processes herein contemplate introducing ingredients including a polymeric material for forming a polymeric article into a processing apparatus (e.g., an extruder of other like device including a screw and barrel assembly). The processing apparatus generally will include one or more components that include a housing with an interior wall surface configuration for defining a cavity through which ingredients travel in a fluidic state. The ingredients ultimately exit the apparatus through at least one orifice. While in the apparatus, the ingredients are subjected to mixing over at least a portion of the length of the apparatus. A blowing reaction may be initiated while the ingredients are present within the apparatus. The operating temperatures within the apparatus or its individual components will typically be in excess of about 100° C. and less than about 300° C. The pressures within the apparatus or its individual components will typically be in the range of about 5 MPa to about 25 MPa. It can generally be said that these conditions may lead to the chemical breakdown and release of moities, that may subsequently form corrosive compounds, for example, a hydrohalic acid.

By way of more specific illustration, FIG. 1 shows a processing apparatus 10 that includes an extruder 12, a mixer 14, a cooling apparatus 16 and a die 18. Ingredients including one or more polymers (and optionally other ingredients, such as a flame retardant) are fed into the extruder and are advanced to the mixer, where a blowing agent is introduced. In the embodiment shown in FIG. 1, the ingredients mixture is advanced to a cooling apparatus 16, before exiting from the die 18, which imparts a shape to the resulting article. It is also possible that one or more of the components (e.g., the cooling apparatus 16) is omitted. It is also contemplated that the blowing agent could be introduced at the extruder, at the mixer, or at some other suitable location within the apparatus.

The process is repeated for making a plurality of parts and therefore could involve a plurality of cycles of the above processing steps. It is also possible that the process is carried out in a continuous manner, by which as articles such as panels or other articles having a constant cross sectional profile (e.g., from extrusion), are cut after exiting the die, and optionally subjected to some additional or secondary processing operation.

For the manufacture of polymeric articles herein, it is contemplated that the ingredients mixture will include one or a plurality of ingredients that create a corrosive environment. By way of example, one specific formulation may include a polystyrene resin, a water and/or carbon dioxide blowing agent, and additives such as one or more of tetrasodium pyrophosphate, filler (e.g., talc). In instances employing such ingredients and a corrosive releasing material such as a brominated fire retardant which is expected to release bromine to form hydrobromic acid. For example, the ingredients mixture can include ingredients that will react in one or more of the extruder 12, the mixer 14, the cooling apparatus 16 or the die 18 to yield an acidic environment. By way of example, for one application, it is contemplated that the ingredients include water or another blowing agent and at least one other ingredient that chemically or physically reacts to form an acid. For example, water may react with a halogenated ingredient such as a brominated flame retardant (e.g., to form hydrobromic acid). An example of one flame retardant is hexabromocyclododecane (“HBCD”). Other brominated flame retardants may be employed, as may other ingredients (e.g. chlorine, sulfur, or the like) that yield an acidic species.

The invention herein makes use of an improved sensor, which is constructed to withstand the processing conditions heretofore not realizable using conventional sensors of such as sensor type. Preferably, the invention contemplates the use of an on-line sensor probe, which desirably includes a sensing element made of a material that is the same as that of the interior wall defining a cavity through which ingredients flow within one or more components of processing apparatus.

With reference to FIG. 2 and FIG. 3, a schematic of an illustrative sensor 20 is shown. The sensor includes a housing 22 including a sensing portion 24 that terminates at a sensing end 26 of the housing. A potting material 28 fills the sensing portion 24 of the housing 22. A metallic sensing element 30 includes an exposed portion 32 (e.g., a foil, a wire, or other thin metallic member) and an embedded portion 34. The embedded portion 34 connects with the exposed portion 32 and is embedded in the potting material 28. The sensing element is connected to a suitable signal communicator 36 (e.g., a wire, a radiofrequency transmitter or other signal transmitter). The signal communicator is in signaling communication with a suitable data acquisition device including signal processor 38 and an electrical source 40. The electrical source may be included as part of the data acquisition device that includes the signal processor 38. The collected data from the data acquisition device can be downloaded to a PC and a software package calculates and plots the corrosion rate vs. time data. For on-line applications, the suitable signal communicator can send the corrosion data to a control room using special cables.

The exposed portion of the sensor is made of a metal having a measurable electrical resistance and being the same or similar composition of metal used for making the interior wall of the processing apparatus (e.g., a ferritic material such as a steel). At any given time, the exposed portion will exhibit an inherent electrical resistance. It is therefore expected, when mounted adjacent (e.g., flush with or substantially flush with) the interior wall, and subjected to the same processing conditions as the interior wall, the exposed portion will corrode at approximately the same rate as the interior wall. With the corrosion, it is expected that the metal of the exposed portion will erode and its inherent electrical resistance to change as well. By monitoring the change in resistance of the exposed portion, and correlating the change with erosion of the metal, it is possible to monitor corrosion of the adjoining interior wall.

As indicated, for a variety of applications in chemical processing, and particularly for processing of ingredients (e.g., ingredients including a thermoplastic polymer) to form a polymeric article, the environment to which the interior wall of the processing apparatus is exposed will be harsh, or even corrosive. It is therefore important that the material selected for the potting material be capable of withstanding such harsh conditions. Preferably, the potting material is selected so that it is capable of resisting deterioration caused by the presence of any corrosive media, any solvent or both. More preferably, the potting material is capable of resisting swelling (or other volumetric increase) of the potting material when subjected to a processing condition for a period of at least one week (more preferably at least one month, and still more preferably at least three months), wherein the process condition includes temperatures ranging from about 100° C. to 300° C., pressures ranging from about 5 to 25 MPa, and exposure to an acidic medium with a pH below about 7, and more preferably below about 5.5 (such as in an acidic environment resulting from the presence of a halogenated flame retardant such as anhydrous hydrogen bromide, hydrobromic acid, and water). It is also contemplated, as discussed previously, that any carbon dioxide may be subject to supercritical conditions effectively rendering it as a solvent. Additionally, it is contemplated that the potting material can resist degradation during potentially lesser and greater environmental conditions and cycles which may be seen during start-up, shut down and down time of the apparatus (e.g. ambient temperatures and pressures during down times). It is also contemplated that under any of the above conditions, the sensor may provide an accurate corrosion reading over time (e.g. within about 10% of an actual measured corrosion for at least seven days, and more preferably within about 5% of an actual measured corrosion for at least one month).

Specific examples of preferred potting materials include ceramic potting materials that are sintered to at least about 98% (and more preferably at least about 99%) theoretical density. The ceramic materials can be selected from silica, fused silica, alumina, zirconia, carbide, boride, nitrides, silicide, or any combination thereof. The ceramic materials may include one or more reinforcement phase, dopant or both, including for example one or more oxide, barium, bismuth, strontium, calcium copper, boron carbide, boron nitride, ferrite (Fe₃O₄), lead zirconate titanate, magnesium diboride, silicon carbide, silicon nitride, steatite, zinc oxide, zirconium dioxide, or any combination or compound thereof.

Turning again to the illustrative processing apparatus, depicted in FIG. 1, one preferred method involves a generally continuous operation of the apparatus for preparing a plurality of articles (e.g. at least 10 or more, preferably at least 100 articles without apparatus shut-down) and more preferably a plurality of styrenic polymeric articles. The styrenic polymeric thermoplastic materials are introduced into the apparatus in such a way as to maintain a continuous flow through the apparatus. For example, the styrenic polymeric thermoplastic polymeric material, along with any number of other materials (e.g. fire retardant stabilizer packages, blowing agents, water) can be introduced to the apparatus either before the extruder 12, at the mixer 14, or any combination thereof. The styrenic polymeric thermoplastic polymeric material is mixed with the other materials to homogenize them. A blowing agent is introduced (e.g., shown in FIG. 1 being introduced at the mixer) into the mixture, for forming a blowing gel that includes gas bubbles, and thus the start of the closed cell structure of the foams. As it is blowing, the gel is cooled, such as by transporting it through one or more cooling apparatus and through the shaping device. It is preferred that any water that is included, is present in an amount that is less than about 10% by weight of the overall ingredients, more preferably in an that is less than about 5% by weight of the overall ingredients, and most preferably in an amount that is less than 3% by weight of the overall ingredients.

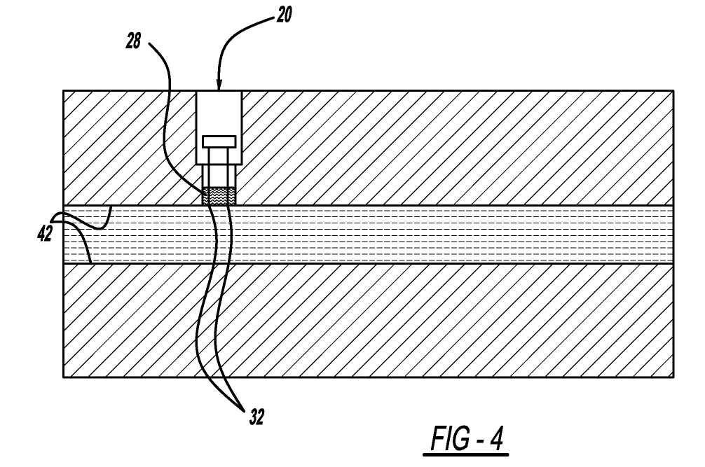

The extruder 12, mixer 14, cooling apparatus 16 and shaping device 18 have at least one wall surface (e.g. an interior wall surface) over which the polymeric material travels in a molten or gelatinous state, and the shaping device has an orifice through which the ingredients exit the apparatus, solidifying the polymeric mixture for forming the polymeric article. The probe herein is typically mounted so that it is flush with the interior surface 42, such as is shown in FIG. 4. Accordingly, the probe will not interfere with the travel of the ingredients.

Accordingly, while ingredients are mixed to form a polymeric ingredients mixture and any corrosive agent is liberated from the mixture, the corrosion response of the interior wall surface of the apparatus is monitored using the improved flush probe. Preferably, the flush probe is located on an interior wall 42 of the apparatus after the mixer 14, such as within the cooling apparatus or in the interconnecting piping, although it is also contemplated that the probe can be located anywhere within the apparatus as a whole that the acquisition of corrosion data may be beneficial (e.g. immediately after the extruder or within the extruder). Also, the invention contemplates the use of multiple flush probes in multiple locations within the apparatus.

The corrosive response is monitored, via a signal from a transmitter (e.g., a hard-wired electrical cable transmitter, a radiofrequency or other wireless transmitter, or both) from the probe to a suitable monitoring device, which will include suitable data acquisition hardware in accordance with art-disclosed teachings. Real-time corrosion rate feedback to the manufacturer is therefore possible, allowing the manufacturer to take steps to implement corrosion mitigation. This corrosion mitigation may include steps of changing processing variables such as, but not limited to: formulation of the mixture, apparatus temperature setting, pressure settings, speed of material flow, choice of apparatus construction materials, and shut down timing for preventative maintenance. This corrosion mitigation may also include steps of adding to the ingredients: a suitable flame retardant stabilizer, an acid scavenger, a desiccant, or any combination thereof. The corrosion mitigation may also include a step of replacing a component with a more corrosion resistant material. These steps and techniques will allow the manufacturer to accurately determine, on an ongoing basis, unlike the pre-measured coupon corrosion tests, corrosion rates so they can be mitigated. In other words, to allow the manufacturer to select formulas and choose apparatus (for critical wetted apparatus parts in corrosive service) to maintain good corrosion resistance (e.g. a corrosive deterioration of less than about 0.15 mm/yr).

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

What is claimed is:

1. A method for processing a polymeric article, comprising the steps of:
a) introducing ingredients including a polymeric material for forming a polymeric article into an apparatus including a wall surface over which the polymeric material travels in at least a fluidic state, and an orifice through which the ingredients exit the apparatus;
b) mixing the ingredients while in the apparatus to form a polymeric ingredients mixture;
c) monitoring a corrosion response of the wall surface of the apparatus with at least one resistance corrosion sensing probe that is flush mounted with the interior wall surface, wherein the at least one resistance corrosion sensing probe provides an accurate contemporaneous corrosion reading within 10% of an actual measured corrosion for at least seven days; and
d) solidifying the polymeric mixture after it exits the orifice for forming the polymeric article.

2. The method of claim 1, wherein the probe further includes a sintered ceramic potting material.

3. The method of claim 1, wherein any water that is present in the polymeric ingredients mixture is present in an amount that is less than 10% by weight of the mixture.

4. The method of claim 1, wherein any water that is present in the polymeric ingredients mixture is present in an amount that is less than 5% by weight of the mixture.

5. The method of claim 1, wherein the polymeric ingredients mixture includes at least two ingredients that chemically or physically react to form an acidic medium.

6. The method of claim 5, wherein the polymeric ingredients mixture includes a flame retardant as one of the at least two ingredients.

7. The method of claim 1, wherein the polymeric ingredients mixture includes a styrenic polymeric thermoplastic material, an aqueous blowing agent and a halogenated flame retardant that react to form an acidic medium and the resulting article is an expanded styrenic polymeric closed-cell foam extruded panel.

8. The method of claim 7, wherein the apparatus includes at least one of an extruder, a mixer, a cooling apparatus, interconnecting piping, and a die, that the probe is mounted within at least one of the mixer, the cooling apparatus, interconnecting piping, or die.

9. The method of claim 8, wherein the aqueous blowing agent and the halogenated flame retardant are introduced individually into the apparatus and thereafter react to form an acidic medium.

10. The method of claim 1, wherein the sensing probe includes:
a) a housing including a sensing portion that terminates at a sensing end of the housing;
b) a potting material filling the sensing portion of the housing;
c) a metallic sensing element including an exposed portion and a portion connected with the exposed portion that is embedded in the potting material;
d) and means for signally communicating the electrical response of the sensing element with a signal processor, pursuant to which erosion of the sensing element results in a change of resistance of the sensing element that is detected by the signal processor;
wherein the potting material is capable of resisting swelling of the potting material when subjected to a processing condition for a period of at least one week, the sensing probe provides an accurate corrosion reading within 10% of an actual measured corrosion for at least seven days and wherein the process condition includes temperatures less than 300° C., pressures less than 25 MPa, an acidic media with a pH below 7, and the presence of a solvent.

11. The method of claim 1, further including the step of mitigating corrosion detected by the monitoring step.

12. The method of claim 11, the mitigating corrosion step further including adding to the ingredients a suitable flame retardant stabilizer, an acid scavenger, a desiccant, or any combination thereof.

13. The method of claim 1, wherein the at least one resistance corrosion sensing probe provides an accurate corrosion reading within 5% of an actual measured corrosion for at least one month.

14. The method of claim 10, wherein the solvent is under super critical conditions.

15. A corrosion sensor, comprising:
a) a housing including a sensing portion that terminates at a sensing end of the housing;
b) a potting material filling the sensing portion of the housing;
c) a metallic sensing element including an exposed portion and a portion connected with the exposed portion that is embedded in the potting material;
d) and means for signally communicating the electrical response of the sensing element with a signal processor, pursuant to which erosion of the sensing element results in a change of resistance of the sensing element that is detected by the signal processor;
wherein the potting material is capable of resisting swelling of the potting material when subjected to a processing condition for a period of at least seven days, the corrosion sensor provides an accurate corrosion reading within 10% of an actual measured corrosion for at least seven days wherein the process condition includes temperatures less than 300° C., pressures less than 25 MPa, an acidic media with a pH below 7, and the presence of a solvent.

16. The corrosion sensor of claim 15, wherein the exposed portion of the metallic sensing element is located generally at the sensing end of the housing so that when the housing is mounted within a piece of apparatus the metallic sensing element is substantially flush with an inner wall of the piece of apparatus.

17. The corrosion sensor of claim 15, wherein the means for signally communicating is a radio frequency transmitting device.

18. Use of the corrosion sensor of claim 15 for processing of chemicals.

19. Use of the corrosion sensor of claim 15 for the manufacture of an expanded styrenic polymeric foam extrudate, further wherein the expanded styrenic polymeric foam extrudate is substantially free from visible flaws or defects attributable to the use of the corrosion sensor.

20. The corrosion sensor of claim 16, wherein the solvent includes liquid and vapor CO₂, ethanol, water or combinations thereof.
